(19) United States
(12) Patent Application Publication
(10) Pub. No.: US 2026/0245940 A1
(43) Pub. Date: Aug. 20, 2026

(54) FUEL CELL DEVICE AND VEHICLE

(71) Applicant: HONDA MOTOR CO., LTD., TOKYO (JP)

(72) Inventors: Takahiro NAGANO, WAKO-SHI (JP); Yoshihiro TAMAI, WAKO-SHI (JP); Yoshitaka MAEDA, WAKO-SHI (JP); Koichi KUROSAWA, WAKO-SHI (JP); Hiroki MORI, WAKO-SHI (JP); Kei YOSHIDA, WAKO-SHI (JP); Kohei KAKUTA, WAKO-SHI (JP); Atsushi SHIMIZU, WAKO-SHI (JP)

(21) Appl. No.: 19/540,894

(22) Filed: Feb. 16, 2026

(30) Foreign Application Priority Data
Feb. 18, 2025 (JP) 2025-024289

(51) Int. Cl. H01M 8/2475; H01M 8/04029

(52) U.S. Cl. CPC H01M 8/2475; H01M 8/04029

(57) ABSTRACT

A fuel cell device includes: a fuel cell stack; auxiliary components; and a support member configured to support the fuel cell stack and the auxiliary components, the support member being attachable to an attachment target, wherein the fuel cell stack is attached to an upper surface of the support member, and the auxiliary components includes: a cooling system component; and reactant gas system components including an oxygen-containing gas system component and a fuel gas system component, wherein the cooling system component is attached to a lower surface of the support member, and at least a part of the reactant gas system components is arranged below the cooling system component.

### CROSS-REFERENCE TO RELATED APPLICATIONS

This application is based upon and claims the benefit of priority from Japanese Patent Application No. 2025-024289 filed on Feb. 18, 2025, the contents of which are incorporated herein by reference.

### BACKGROUND OF THE INVENTION

### Field of the Invention

The present disclosure relates to a fuel cell device and a vehicle.

### Description of the Related Art

In recent years, research and development have been conducted on fuel cell devices that contribute to energy efficiency in order to ensure that more people have access to affordable, reliable, sustainable and modern energy.

JP 2023-163482 A discloses a layout of a fuel cell stack, a cooling system pipe, an anode system pipe, and a cathode system pipe in a fuel cell device.

### SUMMARY OF THE INVENTION

There is a long waited need for a more satisfactory fuel cell system and a more satisfactory vehicle.

The present disclosure has the object of solving the aforementioned problem.

A first aspect of the present disclosure is characterized by a fuel cell device including: a fuel cell stack; auxiliary components connected to the fuel cell stack; and a support member configured to support the fuel cell stack and the auxiliary components, the support member being attachable to an attachment target, wherein the fuel cell stack is attached to an upper surface of the support member, and the auxiliary components includes: a cooling system component configured to circulate a coolant through the fuel cell stack; and reactant gas system components including an oxygen-containing gas system component configured to supply an oxygen-containing gas to the fuel cell stack and a fuel gas system component configured to supply a fuel gas to the fuel cell stack, wherein the cooling system component is attached to a lower surface of the support member, and at least a part of the reactant gas system components is arranged below the cooling system component.

A second aspect of the present disclosure is characterized by a vehicle including the fuel cell device described above, wherein the fuel gas system component is arranged rearward of the fuel cell stack in a front-rear direction of the vehicle.

According to the present disclosure, a more satisfactory fuel cell device and a more satisfactory vehicle can be provided.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a fuel cell device according to an embodiment of the present disclosure;

FIG. 2 is a perspective view of the fuel cell device;

FIG. 3 is a front view of the fuel cell device;

FIG. 4 is a partially omitted cross-sectional view taken along line IV-IV of FIG. 3;

FIG. 5 is an explanatory diagram illustrating an arrangement of auxiliary components.

### DETAILED DESCRIPTION OF THE INVENTION

The fuel cell device includes a fuel cell stack and auxiliary components. The auxiliary components include cooling system components and reactant gas system components. For example, if the cooling system components are disposed on the outer side of the reactant gas system components, the cooling system components may need to be removed when replacing the reactant gas system components during maintenance of the fuel cell device. In this case, since discharging coolant from the cooling system components and returning the coolant to the cooling system components are required, the number of steps required for maintenance may increase. Further, the fuel cell device needs to be configured to be compact with a good weight balance. According to the present disclosure, it is possible to provide a fuel cell device and a vehicle that can be configured compactly with a good weight balance and can suppress an increase in the number of maintenance steps of the reactant gas system components.

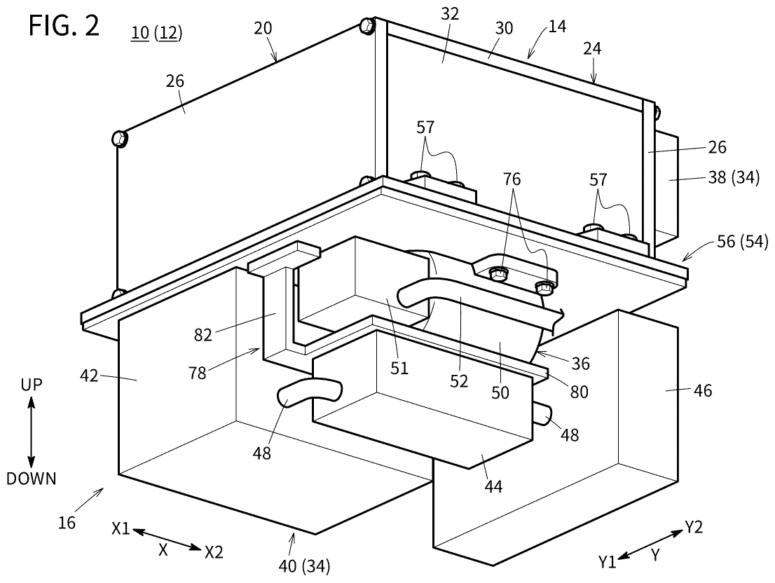

A fuel cell device 10 and a vehicle 12 according to the embodiments of the present disclosure will be described below with reference to the drawings. The fuel cell device 10 is mounted on the vehicle 12 such as a fuel-cell electric vehicle. In FIGS. 2 to 5, the X direction is a vehicle front-rear direction, and the Y direction is a vehicle width direction. The X1 direction extends in the forward direction of the vehicle, and the X2 direction extends in the rearward direction of the vehicle. The fuel cell device 10 may be mounted on a stationary power generation system or the like.

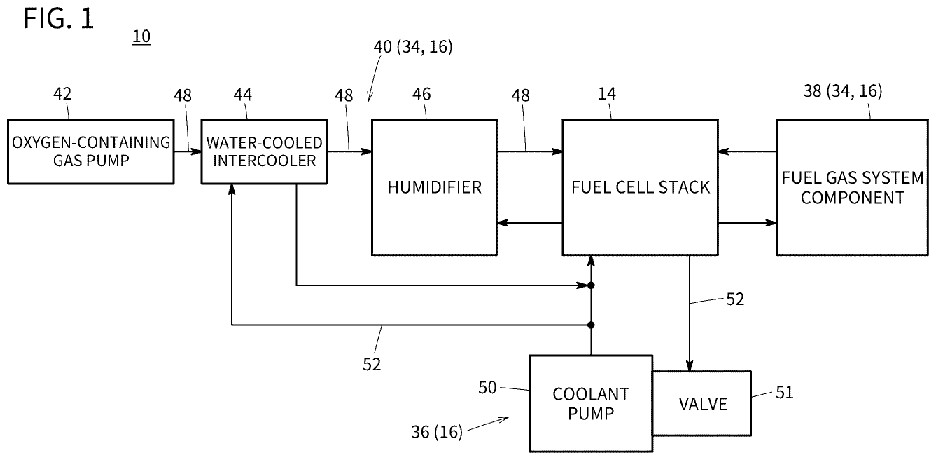

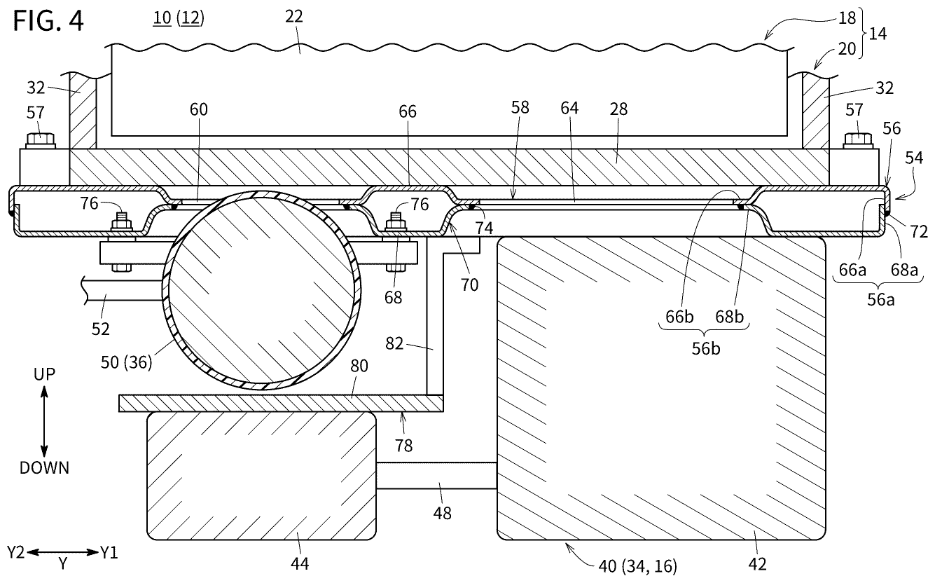

As shown in FIG. 1, the fuel cell device 10 includes a fuel cell stack 14 and auxiliary components 16. As shown in FIG. 4, the fuel cell stack 14 includes a fuel cell main body 18 and a stack case 20. The fuel cell main body 18 is formed by stacking a plurality of power generation cells 22. In the present embodiment, the plurality of power generation cells 22 are stacked in the X direction. The power generation cells 22 generate power by electrochemical reactions between a fuel gas (for example, a hydrogen gas) and an oxygen-containing gas (for example, air).

As shown in FIGS. 2 to 4, the stack case 20 accommodates the fuel cell main body 18. The stack case 20 includes a peripheral wall case 24 and a pair of end plates 26. The peripheral wall case 24 is formed in a quadrangular tubular shape. The peripheral wall case 24 includes a lower plate 28, an upper plate 30, and a pair of side plates 32.

As shown in FIG. 1, the auxiliary components 16 are connected to the fuel cell stack 14. The auxiliary components 16 include reactant gas system components 34 and cooling system components 36. The reactant gas system components 34 include fuel gas system components 38 and oxygen-containing gas system components 40.

The fuel gas system components 38 supply the fuel gas to the fuel cell stack 14. The fuel gas system components 38 include, for example, a fuel gas tank, an injector, an ejector, pipes, valves, and the like.

The oxygen-containing gas system components 40 supply the oxygen-containing gas to the fuel cell stack 14. The oxygen-containing gas system components 40 include an oxygen-containing gas pump 42, a water-cooled intercooler 44, a humidifier 46, and oxygen-containing gas pipes 48. Although the oxygen-containing gas system components 40 may comprise constituent elements other than these components, descriptions of such other components are omitted herein.

The oxygen-containing gas pump 42 is, for example, an air pump that feeds air as the oxygen-containing gas to the fuel cell stack 14. The water-cooled intercooler 44 is a heat exchanger that cools the oxygen-containing gas (in a compressed state) fed from the oxygen-containing gas pump 42. The humidifier 46 humidifies the oxygen-containing gas guided from the water-cooled intercooler 44 by using an oxygen-containing exhaust gas discharged from the fuel cell stack 14. The oxygen-containing gas pipes 48 are connected to the oxygen-containing gas pump 42, the water-cooled intercooler 44, the humidifier 46, and the fuel cell stack 14. The oxygen-containing gas pipes 48 are made of, for example, a resin material and has flexibility.

The cooling system components 36 circulate the coolant through the fuel cell stack 14. The cooling system components 36 include a coolant pump 50, a valve 51, and coolant pipes 52. Although the cooling system components 36 may comprise constituent elements other than these components, descriptions of such other components are omitted herein. The coolant pump 50 feeds the coolant to the fuel cell stack 14. The coolant pump 50 feeds the coolant also to the water-cooled intercooler 44. The coolant pipes 52 are connected to the coolant pump 50, the water-cooled intercooler 44, and the fuel cell stack 14. The coolant pipes 52 are made of, for example, a metal material.

As shown in FIG. 2, the fuel cell device 10 includes a support member 54 that supports the fuel cell stack 14 and the auxiliary components 16. The support member 54 can be attached to an attachment target (not shown). Examples of the attachment target include a vehicle body frame. The attachment target may be a frame of a stationary power generation system.

The support member 54 includes a support plate 56. The fuel cell stack 14 is mounted on the upper surface of the support plate 56 (support member 54) by a plurality of bolts 57. That is, since the fuel cell stack 14 is attached to the upper surface of the support member 54 attachable to the attachment target, the arrangement of the fuel cell stack 14 with respect to the attachment target can be flexibly changed as compared with the case where the fuel cell stack 14 is directly attached to the attachment target.

The fuel cell stack 14 is detachably attached to the support member 54. In this case, when maintenance of the fuel cell stack 14 is performed, it is not necessary to remove the support member 54 from the attachment target, and thus the number of maintenance steps of the fuel cell stack 14 can be reduced. At least one of the auxiliary components 16 is attached to the lower surface of the support plate 56. With this arrangement, it is possible to make the fuel cell device 10 compact.

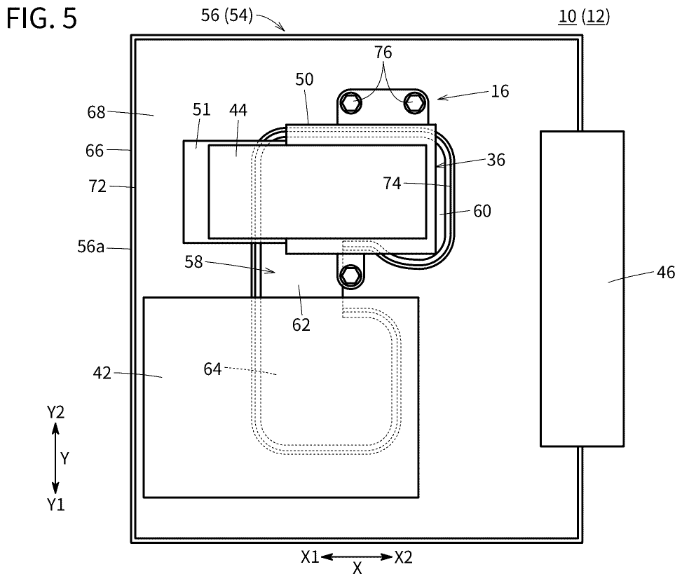

As shown in FIG. 5, the support plate 56 is formed in an annular shape. An opening 58 penetrating the support plate 56 in the up-down direction is formed in the central portion of the support plate 56. An outer peripheral edge 56a of the support plate 56 is formed in a rectangular shape when viewed from above.

The opening 58 is defined by a first hole 60, a second hole 62, and a third hole 64. The first hole 60 is located in the Y2 direction relative to the center of the support plate 56 in the Y direction. The second hole 62 is connected to and extends from the first hole 60 in the Y1 direction. The third hole 64 is connected to a Y1-direction end of the second hole 62. The X-direction width of the first hole 60 is greater than the X-direction width of the second hole 62. The X-direction width of the third hole 64 is smaller than the X-direction width of the first hole 60 and greater than the X-direction width of the second hole 62.

As shown in FIG. 4, the support plate 56 includes an upper metal plate 66 and a lower metal plate 68 that form a structure 70 having a hollow cross section. This makes it possible to increase rigidity of the support plate 56 while reducing the weight of the support plate 56. Each of the upper metal plate 66 and the lower metal plate 68 is, for example, a steel plate, but is not limited thereto.

An outer peripheral edge 66a of the upper metal plate 66 and an outer peripheral edge 68a of the lower metal plate 68 overlap each other. The outer peripheral edge 66a of the upper metal plate 66 and the outer peripheral edge 68a of the lower metal plate 68 are joined to each other at a joint portion 72 (hereinafter, also referred to as “outer joint portion 72”). In other words, the outer joint portion 72 is provided at the outer peripheral edge 56a of the support plate 56. The outer joint portion 72 extends in a quadrangular shape along the outer peripheral edge 56a of the support plate 56. The outer joint portion 72 is not limited to the example of extending in a quadrangular shape, and may be provided at intervals along the outer peripheral edge 56a of the support plate 56.

An inner peripheral edge 66b of the upper metal plate 66 that forms the opening 58 and an inner peripheral edge 68b of the lower metal plate 68 that forms the opening 58 overlap each other. The inner peripheral edge 66b of the upper metal plate 66 and the inner peripheral edge 68b of the lower metal plate 68 are joined to each other at a joint portion 74 (hereinafter, also referred to as “inner joint portion 74”). In other words, the inner joint portion 74 is provided at an inner peripheral edge 56b of the support plate 56. The inner joint portion 74 extends along the opening 58. This increases rigidity of the inner peripheral edge 56b of the support plate 56. The inner joint portion 74 may be provided at intervals along the inner peripheral edge 56b of the support plate 56.

Each of the outer joint portion 72 and the inner joint portion 74 is, for example, a welded portion formed by welding the upper metal plate 66 and the lower metal plate 68. Such a welded portion may be formed by, for example, laser welding, TIG welding, MIG welding, or the like. Each of the outer joint portion 72 and the inner joint portion 74 is not limited to such a welded portion, and may be formed by, for example, friction stir welding.

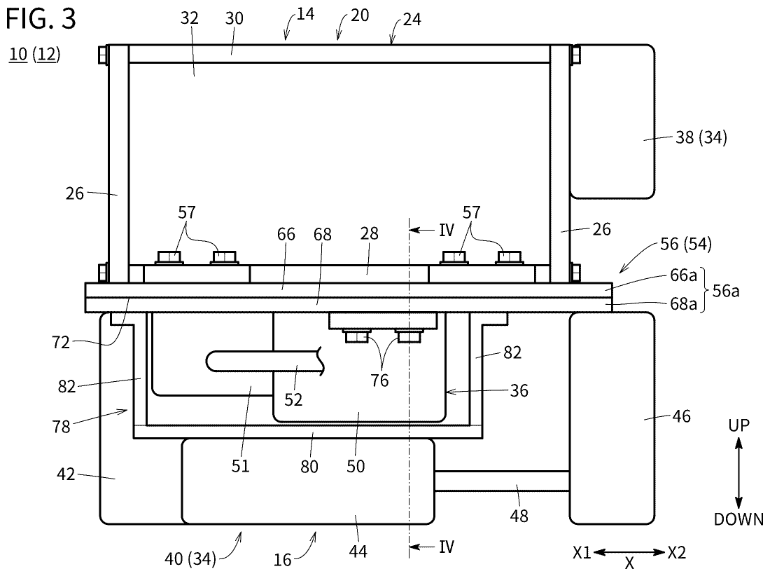

Next, a specific arrangement configuration (layout) of the auxiliary components 16 will be described. In FIGS. 2 to 4, piping is partially omitted. In FIG. 5, piping is not omitted. As shown in FIGS. 2 and 3, the fuel gas system components 38 are disposed rearward of the fuel cell stack 14 in the vehicle front-rear direction (in the X2 direction). Thus, for example, in the event of a head-on collision of the vehicle 12 (in the event of a collision of the vehicle 12 with an obstacle or the like in front of the vehicle 12), the fuel cell stack 14 can prevent the fuel gas system components 38 from being hardly hit by the front part of the vehicle 12.

The fuel gas system components 38 are attached, by unillustrated bolts or the like, to a side surface of the fuel cell stack 14 facing the rear of the vehicle (the side surface facing the X2 direction). This makes it possible to shorten the length of the pipe for supplying the fuel gas to the fuel cell stack 14, and thus to make the fuel cell device 10 compact. Further, it is possible to suppress vibration and noise caused when supplying the fuel gas from the fuel gas system components 38 (vibration and noise caused when the fuel gas is injected from the injector).

As shown in FIG. 4, the cooling system components 36 are attached to the lower surface of the support plate 56 (support member 54). Specifically, the coolant pump 50 is attached to the lower surface of the support plate 56 by a plurality of bolts 76 at positions (the positions of the bolts 76) adjacent to the inner joint portion 74. This enables the coolant pump 50 (the cooling system components 36) to be stably supported. The coolant pump 50 is arranged partially inside the first hole 60. This makes it possible to reduce the size of the fuel cell device 10 in the up-down direction. The valve 51 is attached to the coolant pump 50.

As shown in FIGS. 2 to 5, the oxygen-containing gas pump 42 is directly attached to the lower surface of the support plate 56 (support member 54) by unillustrated bolts. The oxygen-containing gas pump 42 is disposed to cover the third hole 64 from below (see FIG. 5). The oxygen-containing gas pump 42 is arranged in the Y1 direction relative to the coolant pump 50. The size of the oxygen-containing gas pump 42 is larger than the size of the coolant pump 50.

The water-cooled intercooler 44 is arranged below the cooling system components 36 (the coolant pump 50). At the center of the support member 54, the fuel cell stack 14, the cooling system components 36 (the coolant pump 50), and the oxygen-containing gas system components 40 (the water-cooled intercooler 44) are disposed in this order from the upper side to the lower side. This improves the weight balance of the fuel cell device 10. The height dimension of the water-cooled intercooler 44 is smaller than the height dimension of each of the oxygen-containing gas pump 42 and the humidifier 46 (see FIG. 3). Therefore, even when the coolant pump 50 and the water-cooled intercooler 44 are arranged one above the other in the height direction, it is possible to suppress an increase in the height dimension of the entire fuel cell device 10.

As shown in FIGS. 2 to 4, the water-cooled intercooler 44 is attached to the lower surface of the support plate 56 (support member 54) via a connection member 78. The connection member 78 includes a main body 80 and a plurality of legs 82. The main body 80 extends in the X direction. The main body 80 is arranged below the coolant pump 50. The water-cooled intercooler 44 is attached to the lower surface of the main body 80 by unillustrated bolts. The plurality of legs 82 extend upward from the main body 80. The upper ends of the legs 82 are attached to the lower surface of the support plate 56 by unillustrated bolts. This enables stable attachment of the water-cooled intercooler 44 at a position lower than the coolant pump 50.

As shown in FIGS. 2, 3, and 5, the humidifier 46 is arranged at the X2-directional end and the Y-directional central portion of the support plate 56. The humidifier 46 is directly attached to the lower surface of the support plate 56 (support member 54) by unillustrated bolts. The humidifier 46 is located below the fuel gas system components 38 (see FIGS. 2 and 3). The humidifier 46 protrudes in the X2 direction relative to the X2-directional end of the support plate 56.

Maintenance such as replacement of some of the reactant gas system components 34 of the fuel cell device 10 configured as described above may be performed. Specifically, for example, the oxygen-containing gas pipe 48 connected to the water-cooled intercooler 44 may be replaced. In the fuel cell device 10, the water-cooled intercooler 44 is disposed below the coolant pump 50. In other words, the oxygen-containing gas pipe 48 connected to the water-cooled intercooler 44 is located below the coolant pipe 52 connected to the valve 51. Therefore, when maintenance of the oxygen-containing gas pipe 48 is performed, it is not necessary to remove the cooling system components 36 (for example, the coolant pipe 52). That is, discharging a coolant from the cooling system components 36 and returning the coolant to the cooling system components 36 are not required. That is, it is possible to suppress an increase in the number of steps required for the maintenance of the oxygen-containing gas system components 40.

According to the present embodiment, since a part of the reactant gas system components 34 is disposed below the cooling system components 36, maintenance such as replacement of the part of the reactant gas system components 34 can be performed without removing a part of the cooling system components 36. This can suppress an increase in the number of steps required for the maintenance of the reactant gas system components 34. Further, since the fuel cell stack 14, the cooling system components 36, and a part of the reactant gas system components 34 are arranged in the up-down direction, the fuel cell device 10 can be configured compactly with a good weight balance. Further, since the fuel cell stack 14 is attached to the upper surface of the support member 54 attachable to the attachment target, the arrangement of the fuel cell stack 14 with respect to the attachment target can be flexibly changed as compared with the case where the fuel cell stack 14 is directly attached to the attachment target. Therefore, a more favorable fuel cell device 10 can be provided.

In relation to the above-described embodiment, the following supplementary notes are further disclosed.

### Supplementary Note 1

The fuel cell device (10) of the present disclosure includes: the fuel cell stack (14); the auxiliary components (16) connected to the fuel cell stack; and the support member (54) configured to support the fuel cell stack and the auxiliary components, the support member being attachable to an attachment target, wherein the fuel cell stack is attached to an upper surface of the support member, and the auxiliary components includes: the cooling system component (36) configured to circulate a coolant through the fuel cell stack; and the reactant gas system components (34) including the oxygen-containing gas system component (40) configured to supply an oxygen-containing gas to the fuel cell stack and the fuel gas system component (38) configured to supply a fuel gas to the fuel cell stack, wherein the cooling system component is attached to a lower surface of the support member, and at least a part of the reactant gas system components is arranged below the cooling system component.

According to this configuration, since a part of the reactant gas system components is disposed below the cooling system component, maintenance such as replacement of the part of the reactant gas system components can be performed without removing part of the cooling system component. This can suppress an increase in the number of steps required for the maintenance of the reactant gas system components. Further, since the fuel cell stack, the cooling system component, and a part of the reactant gas system components are arranged in the up-down direction, the fuel cell device can be configured compactly with a good weight balance. Further, since the fuel cell stack is attached to the upper surface of the support member attachable to an attachment target, the arrangement of the fuel cell stack with respect to the attachment target can be flexibly changed as compared with the case where the fuel cell stack is directly attached to the attachment target. Therefore, a more favorable fuel cell device can be provided.

### Supplementary Note 2

In the fuel cell device according to Supplementary Note 1, at least a part of the oxygen-containing gas system component may be disposed below the cooling system component.

According to this configuration, it is possible to suppress an increase in the number of steps required for the maintenance of the oxygen-containing gas system component.

### Supplementary Note 3

In the fuel cell device according to Supplementary Note 1 or 2, the fuel gas system component may be attached to a side surface of the fuel cell stack.

According to this configuration, it is possible to shorten the length of the pipe for supplying the fuel gas to the fuel cell stack, and thus to make the fuel cell device further compact. Further, since the fuel gas system component is attached to the side surface of the fuel cell stack, it is possible to suppress vibration and noise caused when the fuel gas is supplied from the fuel gas system component.

### Supplementary Note 4

In the fuel cell device according to any one of Supplementary Notes 1 to 3, the fuel cell stack may be attachable to and detachable from the support member.

According to such a configuration, the number of steps required for maintenance of the fuel cell stack can be reduced.

### Supplementary Note 5

A vehicle according to the present disclosure is the vehicle (12) including the fuel cell device according to any one of Supplementary Notes 1 to 4, wherein the fuel gas system component is arranged rearward of the fuel cell stack in the front-rear direction of the vehicle.

According to such a configuration, for example, in the event of a head-on collision of the vehicle (in the event of a collision of the vehicle with an obstacle or the like in front of the vehicle), the fuel cell stack can prevent the fuel gas system components from being hardly hit by the front part of the vehicle.

Although concerning the present disclosure, a detailed description thereof has been presented above, the present disclosure is not necessarily limited to the individual embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A fuel cell device comprising: a fuel cell stack;
auxiliary components connected to the fuel cell stack; and
a support member configured to support the fuel cell stack and the auxiliary components, the support member being attachable to an attachment target, wherein
the fuel cell stack is attached to an upper surface of the support member, and
the auxiliary components includes:
a cooling system component configured to circulate a coolant through the fuel cell stack; and
reactant gas system components including an oxygen-containing gas system component configured to supply an oxygen-containing gas to the fuel cell stack and a fuel gas system component configured to supply a fuel gas to the fuel cell stack, wherein
the cooling system component is attached to a lower surface of the support member, and
at least a part of the reactant gas system components is arranged below the cooling system component.

2. The fuel cell device according to claim 1, wherein
at least a part of the oxygen-containing gas system component is disposed below the cooling system component.

3. The fuel cell device according to claim 1, wherein
the fuel gas system component is attached to a side surface of the fuel cell stack.

4. The fuel cell device according to claim 1, wherein
the fuel cell stack is attachable to and detachable from the support member.

5. A vehicle comprising the fuel cell device according to claim 1, wherein
the fuel gas system component is arranged rearward of the fuel cell stack in a front-rear direction of the vehicle.
